(19) United States
(12) Patent Application Publication
(10) Pub. No.: US 2012/0051861 A1
(43) Pub. Date: Mar. 1, 2012

(54) GUIDE ARRANGEMENT FOR A CUTTING TOOL AND CUTTING TOOL INCLUDING A GUIDE ARRANGEMENT

(75) Inventor: Lilian Rimet, Saint Sauveur (FR)

(73) Assignee: Seco Tools AB, Fagersta (SE)

(21) Appl. No.: 13/202,367

(22) PCT Filed: Feb. 17, 2010
(86) PCT No.: PCT/SE2010/050179

§ 371 Date: Sep. 14, 2011

(30) Foreign Application Priority Data
Feb. 20, 2009 (SE) 09500096-8

(51) Int. Cl. B23B 41/02

(52) U.S. Cl. 408/83

(57) ABSTRACT

A guide arrangement for a cutting tool includes a pad having a guide surface and a hole extending from a first surface of the pad to a second surface of the pad. The guide arrangement further includes a clamping member having a small end and a large end, the large end contacting a clamping surface of the hole proximate the first surface of the pad and the small end extending through the hole and beyond the second surface of the pad. A resilient member is disposed on a surface of the pad opposite the guide surface.

### BACKGROUND AND SUMMARY

The present invention relates generally to cutting tools and, more particularly, to cutting tools having guide arrangements.

To produce holes with good quality in terms of geometry and size, it is often necessary to use tools such as reamers. Reamers are very precise tools with two main functions combined: a cutting function and a guiding function. Reamers typically have cutting edges to perform the cutting function and guides such as land margins on cutting inserts or discrete guide pads to guide the tool in the hole produced by the reamer. Many reamers braze cutting inserts and guide pads to a tool body.

Recently, reamers with indexable inserts have been introduced wherein the inserts have no land margins. These reamers can be subject to problems with vibration during reaming. It is desirable to provide a rotating tool, such as a reaming tool, with a guide arrangement. It is further desirable to provide a rotating tool, such as a reaming tool, with a guide arrangement that does not require the presence of insert land margins to properly guide the tool.

According to an aspect of the present invention, a guide arrangement for a cutting tool comprises a pad having a guide surface and a hole extending from a first surface of the pad to a second surface of the pad, a clamping member having a small end and a large end, the large end contacting a clamping surface of the hole proximate the first surface of the pad and the small end extending through the hole and beyond the second surface of the pad, and a resilient member disposed on a surface of the pad opposite the guide surface.

### BRIEF DESCRIPTION OF THE DRAWINGS

The features and advantages of the present invention are well understood by reading the following detailed description in conjunction with the drawings in which like numerals indicate similar elements and in which:

FIG. 1A is a perspective view of a cutting tool according to an aspect of the present invention, and FIG. 1B is an enlarged view of portion of FIG. 1A;

FIG. 2 is a partially cross-sectional view of a portion of a cutting tool according to an embodiment of the present invention; and

FIG. 3A is a perspective view of a cutting tool according to an aspect of the present invention, and FIG. 3B is an enlarged view of portion of FIG. 3A.

### DETAILED DESCRIPTION

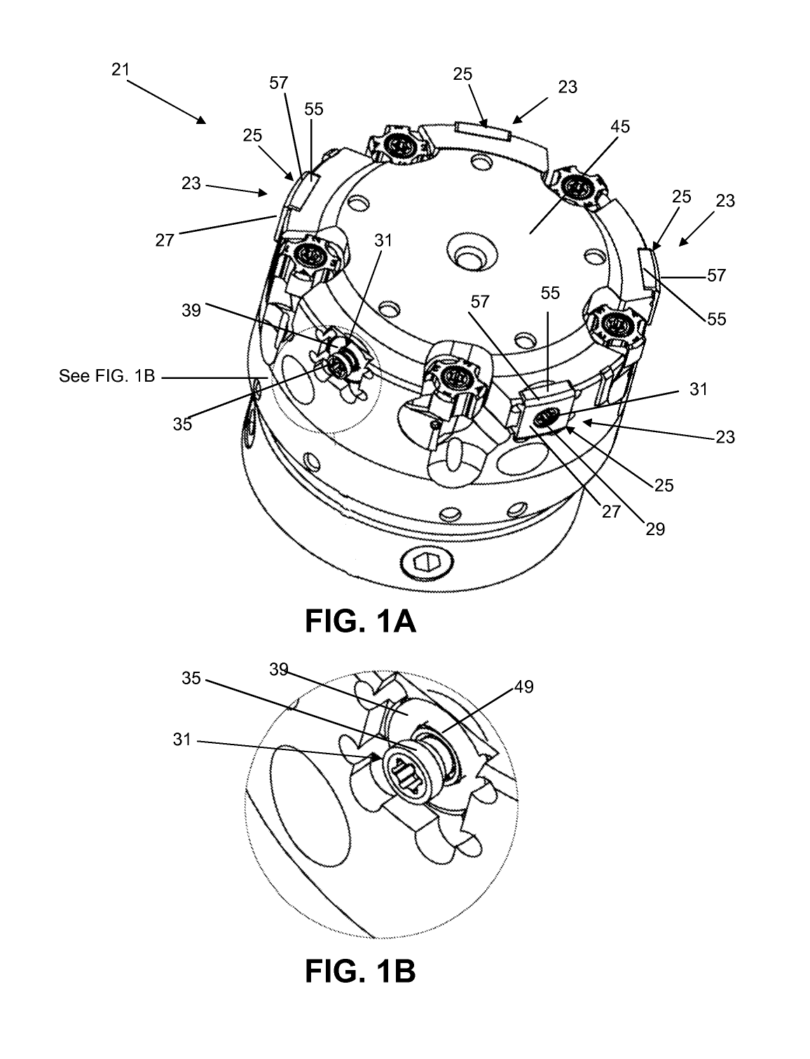

A cutting tool 21 including a guide arrangement 23 is shown in FIGS. 1A-3B. The cutting tool 21 can be any form of rotating tool, however, it is believed that the application has particular application in reaming tools. The guide arrangement 23 includes a pad 25 having a guide surface 27 and a hole 29 extending from a first surface of the pad to a second surface of the pad.

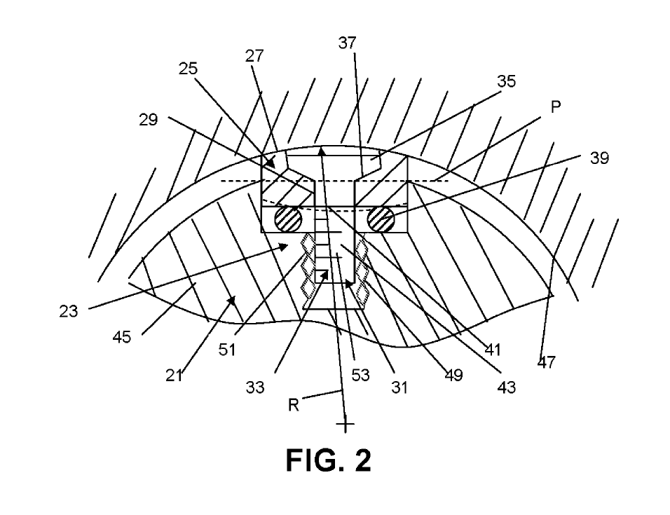

The guide arrangement 23 further comprises a clamping member 31 having a small end 33 (FIG. 2) and a large end 35. Ordinarily, the clamping member 31 will be a structure such as a bolt, a screw, or a pin having an enlarged head portion. The large end 35 contacts a clamping surface 37 (FIG. 2) of the hole 29 proximate the first surface of the pad 25 and the small end extends through the hole and beyond the second surface of the pad.

The guide arrangement 23 further comprises a resilient member 39 disposed on a surface 41 (FIG. 2) of the pad opposite the guide surface 27. Ordinarily, the guide surface 27 is on the first surface of the pad 25, and the resilient member 39 is disposed on the second surface of the pad, i.e., the surface 41 opposite the guide surface 27. The resilient member 39 can comprise a structure such as a compressible, rubber ring that is adapted to be disposed around a portion 43 of the small end 33 of the clamping member 31 extending beyond the second surface (here, the surface 41 opposite the guide surface 27) of the pad 25.

By providing a resilient member 39 on a surface 41 of the pad 25 opposite the guide surface 27, when the resilient member is compressed by a force on the guide surface, the resilient member will apply an opposing force on the surface opposite the guide surface so that the guide surface will be urged into contact with the wall of the hole being, e.g., reamed. In this way, the resilient member 39 facilitates maintaining contact between the guide surface 27 and the surface of the hole, thereby minimizing vibration of the tool relative to the workpiece 47 (FIG. 2). In addition, by providing the resilient member 39 in the form of an O-ring between the body 45 of the tool 21 and the opposite surface 41 of the pads 25, a substantially balanced force can be applied to the opposite surface so that the guide surfaces 27 will be properly oriented relative to the body of the tool. Where several guide arrangements 23 are provided around the circumference of the tool 21, the tool can be “self centering” in the sense that substantially balanced force is applied over the opposite surface 41 of the several pads 25 so that the guide surfaces 27 will automatically tend to properly position the tool relative to the wall of the workpiece.

As shown in phantom in FIG. 2, the first surface and the second surface (here the guide surface 27 and the surface 41 opposite the guide surface) of the pad 25 can be identical. The hole 29 can be symmetrical about a central plane P of the pad 25 perpendicular to an axis of the hole. In this way, the pad 25 can be indexable to at least two positions by flipping it over, such as when damage to one side of the pad occurs.

The pad 25 is ordinarily rectangular and, more particularly, square, when viewed along the axis of the hole 29. As seen, for example, in FIG. 2, the guide surface 27 is ordinarily curved, usually having a radius R substantially equal to or slightly less than a radius of a hole in the workpiece 47 to be cut by the cutting tool. The resilient member 39 typically comprises a ring having a diameter equal to or, typically, slightly smaller than a length of any edge of the pad 25.

As seen, for example, in FIG. 2, a thread 49 such as a thread insert of the type HELICOIL® can be disposed around the portion 43 of the small end 33 of the clamping member 31 extending beyond the second surface of the pad 25. The thread 49 is disposed in a hole 51 in the body 45 of the tool 21. The hole 51 may have an internal thread to mate with the exterior of the thread insert. The small end 33 of the clamping member 31 can have an external thread 53 that mates with the interior of the thread 49.

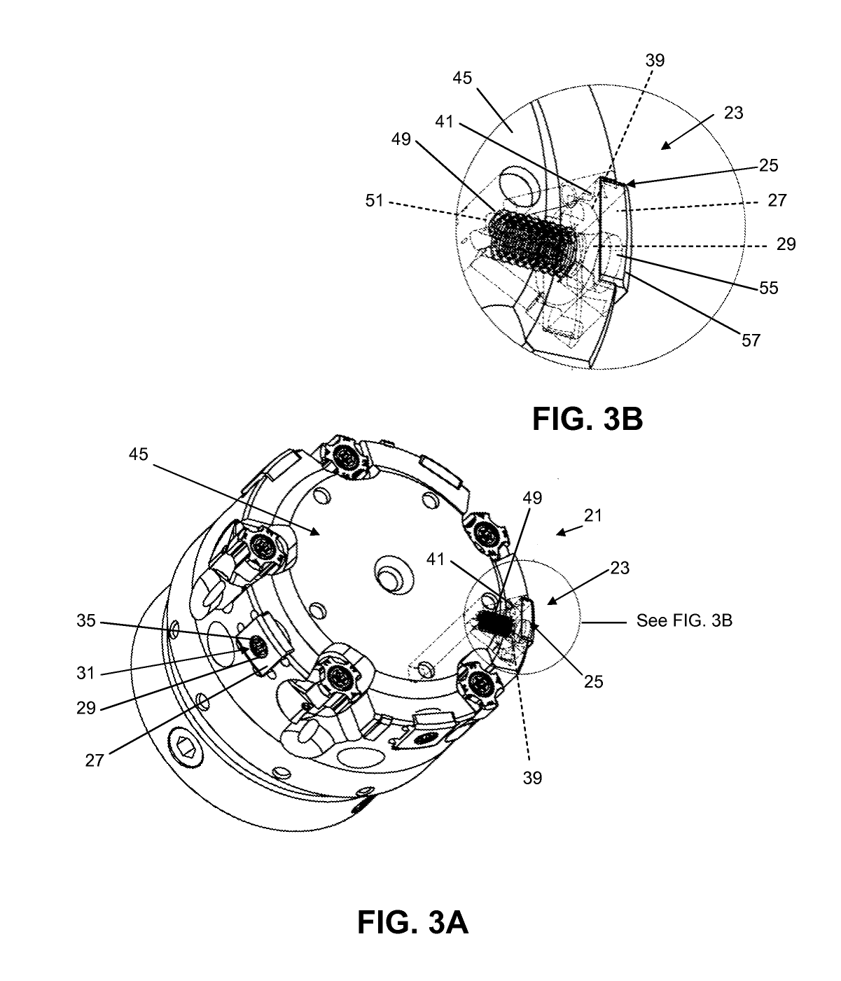

The guide surface 27 defines a circumferential guide surface, i.e., a guide surface defining the limits of the circumference of the tool as it rotates about its axis of rotation. As seen in FIGS. 1A-1B and 3A-3B, the pad 25 can also comprise an edge surface 55 between the circumferential guide surface 27 and the opposite surface 41. The edge surface 55 can comprise an axial guide surface, such as when the pad 25 is disposed at an axial end of the tool. A chamfer 57 can be provided between the circumferential guide surface 27 and the axial guide surface formed by the edge surface 55. The ability of the pad 25 to float relative to the body 47 of the tool 21 along the axis of the clamping member 31 can provide for some ability of the pad to float transverse to the axis of the clamping member. The pad 25 can have two identical edge surfaces 55 on opposite sides of the pad so that, if one edge surface is worn or damaged, the pad can be indexed to use the other edge surface.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

1. A guide arrangement for a cutting tool, comprising
a pad having a guide surface and a hole extending from a first surface of the pad to a second surface of the pad;
a clamping member having a small end and a large end, the large end contacting a clamping surface of the hole proximate the first surface of the pad and the small end extending through the hole and beyond the second surface of the pad; and
a resilient member disposed on a surface of the pad opposite the guide surface.

2. The guide arrangement as set forth in claim 1, wherein the guide surface is on the first surface of the pad.

3. The guide arrangement as set forth in claim 1, wherein the resilient member is disposed on the second surface of the pad.

4. The guide arrangement as set forth in claim 1, wherein the resilient member comprises a ring.

5. The guide arrangement as set forth in claim 4, wherein the ring is disposed around a portion of the small end of the clamping member extending beyond the second surface of the pad.

6. The guide arrangement as set forth in claim 1, wherein the first surface and the second surface of the pad are identical, and the hole is symmetrical about a central plane of the pad perpendicular to an axis of the hole, such that the pad is indexable to at least two positions.

7. The guide arrangement as set forth in claim 1, wherein the pad is rectangular when viewed along an axis of the hole.

8. The guide arrangement as set forth in claim 7, wherein the guide surface is curved.

9. The guide arrangement as set forth in claim 8, wherein the guide surface has a radius (R) substantially equal to a radius of a hole to be cut by the cutting tool.

10. The guide arrangement as set forth in claim 9, wherein the resilient member comprises a ring having a diameter smaller than a length of any edge of the pad.

11. The guide arrangement as set forth in claim 1, wherein the guide arrangement comprises a thread disposed around at least a portion of the small end of the clamping member extending beyond the second surface of the pad.

12. The guide arrangement as set forth in claim 11, wherein the portion of the small end of the clamping member comprises an external thread that mates with the thread.

13. The guide arrangement as set forth in claim 1, wherein the guide surface defines a circumferential guide surface, the pad comprising an edge surface between the circumferential guide surface and the opposite surface, the edge surface comprising an axial guide surface.

14. The guide arrangement as set forth in claim 13, wherein the pad comprises a chamfer between the circumferential guide surface and the axial guide surface.

15. A cutting tool comprising a guide arrangement as set forth in claim 1.
